(19) United States
(12) Patent Application Publication
(10) Pub. No.: US 2026/0299351 A1
(43) Pub. Date: Oct. 1, 2026

(54) DISPLAY DEVICE

(71) Applicant: Japan Display Inc., Tokyo (JP)

(72) Inventors: Kazunari TOMIZAWA, Tokyo (JP); Yosuke HYODO, Tokyo (JP)

(21) Appl. No.: 19/577,811

(22) Filed: Mar. 25, 2026

(30) Foreign Application Priority Data
Mar. 31, 2025 (JP) 2025-058777

(51) Int. Cl. G02F 1/1335; G02F 1/1347

(52) U.S. Cl. CPC G02F 1/133528; G02F 1/133514; G02F 1/1347; G02F 1/133504

(57) ABSTRACT

A display device includes: a light source device; a first polarizing plate on which light from the light source device is incident; a first liquid crystal display panel on which light from the first polarizing plate is incident; a second liquid crystal display panel on which light from the first liquid crystal display panel is incident; and a second polarizing plate on which light from the second liquid crystal display panel is incident. The first and second liquid crystal display panels each include sub pixels including a first sub pixel having a first color filter, a second sub pixel having a second color filter, and a third sub pixel having a third color filter, and are disposed such that at least the first color filter of the first liquid crystal display panel and the second color filter of the second liquid crystal display panel overlap in plan view.

### CROSS-REFERENCE TO RELATED APPLICATION

This application claims the benefit of priority from Japanese Patent Application No. 2025-058777 filed on Mar. 31, 2025, the entire contents of which are incorporated herein by reference.

### BACKGROUND

### 1. Technical Field

What is disclosed herein relates to a display device.

### 2. Description of the Related Art

Japanese Patent Application Laid-open Publication No. 2019-008200 (JP-A-2019-008200) discloses, as an example of a display device, a wristwatch-type electronic apparatus such as a so-called smartwatch. The display device of JP-A-2019-008200 includes a first display panel and a second display panel that are disposed so as to overlap each other in plan view with an air layer interposed therebetween. The first display panel is capable of color display, and the second display panel is capable of monochrome display.

With the technology of the display device disclosed in JP-A-2019-008200, moire may occur when the first display panel and the second display panel both constitute liquid crystal display panels capable of color display with color filters.

For the foregoing reasons, there is a need for reducing occurrence of moire in a display device in which two liquid crystal display panels are disposed so as to overlap each other in plan view.

### SUMMARY

According to an aspect, a display device includes: a light source device; a first polarizing plate on which light from the light source device is incident and through which linearly-polarized light having a first polarization direction is transmitted; a first liquid crystal display panel on which light transmitted through the first polarizing plate is incident; a second liquid crystal display panel that is disposed so as to be spaced apart from the first liquid crystal display panel and on which light transmitted through the first liquid crystal display panel is incident; and a second polarizing plate on which light transmitted through the second liquid crystal display panel is incident and through which linearly-polarized light having a second polarization direction different from the first polarization direction is transmitted. No polarizing plate is disposed between the first liquid crystal display panel and the second liquid crystal display panel. A plurality of sub pixels are disposed in a matrix having a row-column configuration in each of the first liquid crystal display panel and the second liquid crystal display panel such that the sub pixels are arranged along a row direction and a column direction. The sub pixels include a first sub pixel having a first color filter, a second sub pixel having a second color filter, and a third sub pixel having a third color filter. The first color filter, the second color filter, and the third color filter are different in color from each other. The first liquid crystal display panel and the second liquid crystal display panel are disposed such that at least the first color filter of the first liquid crystal display panel and the second color filter of the second liquid crystal display panel overlap each other in plan view.

### BRIEF DESCRIPTION OF THE DRAWINGS

FIG. 1 is a schematic diagram illustrating the configuration of a display device according to a first embodiment of the present disclosure;

FIG. 2 is a plan view of a liquid crystal display panel illustrated in FIG. 1;

FIG. 3 is a diagram illustrating a circuit configuration of the liquid crystal display panel illustrated in FIG. 2;

FIG. 4 is a sectional view of the liquid crystal display panel illustrated in FIG. 2;

FIG. 5 is a diagram illustrating an arrangement of sub pixels in a second liquid crystal display panel illustrated in FIG. 1;

FIG. 6 is a diagram illustrating an arrangement of sub pixels in a first liquid crystal display panel illustrated in FIG. 1;

FIG. 7 is a schematic diagram of a display device according to a comparative example for illustrating moire;

FIG. 8 is a diagram illustrating an array of sub pixels of the first liquid crystal display panel and an array of sub pixels of the second liquid crystal display panel when the display device according to the comparative example illustrated in FIG. 7 is viewed along a Z direction by a user;

FIG. 9 is a diagram illustrating the array of the sub pixels of the first liquid crystal display panel and the array of the sub pixels of the second liquid crystal display panel when the display device according to the comparative example illustrated in FIG. 7 is viewed along a first tilted direction by the user;

FIG. 10 is a diagram illustrating the array of the sub pixels of the first liquid crystal display panel and the array of the sub pixels of the second liquid crystal display panel when the display device according to the comparative example illustrated in FIG. 7 is viewed along a second tilted direction by the user;

FIG. 11 is a diagram illustrating the relation between the luminance of light transmitted through a second polarizing plate and the amount of shift in an X direction between the sub pixels of the first liquid crystal display panel and the sub pixels of the second liquid crystal display panel when the display device is in a white display state;

FIG. 12 is a diagram illustrating the relation between the luminance of light transmitted through the second polarizing plate and the amount of shift in a Y direction between the sub pixels of the first liquid crystal display panel and the sub pixels of the second liquid crystal display panel when the display device in FIG. 1 and the display device according to the comparative example are in a white display state;

FIG. 13 is a diagram illustrating the positional relation between the sub pixels of the first liquid crystal display panel and the sub pixels of the second liquid crystal display panel in the display device in FIG. 1;

FIG. 14 is a diagram illustrating an arrangement of sub pixels in the first liquid crystal display panel included in a display device according to a second embodiment of the present disclosure;

FIG. 15 is a diagram illustrating the positional relation between the sub pixels of the first liquid crystal display panel and sub pixels of the second liquid crystal display panel in the display device according to the second embodiment;

FIG. 16 is a diagram illustrating the relation between the luminance of light transmitted through the second polarizing plate and the amount of shift in the X direction between the sub pixels of the first liquid crystal display panel and the sub pixels of the second liquid crystal display panel when the display device according to the second embodiment is in white display;

FIG. 17 is a diagram illustrating the relation between the luminance of light transmitted through the second polarizing plate and the amount of shift in the Y direction between the sub pixels of the first liquid crystal display panel and the sub pixels of the second liquid crystal display panel when the display device according to the second embodiment is in white display;

FIG. 18 is a diagram illustrating an arrangement of sub pixels in the first liquid crystal display panel included in a display device according to a third embodiment of the present disclosure;

FIG. 19 is a diagram illustrating the positional relation between the sub pixels of the first liquid crystal display panel and sub pixels of the second liquid crystal display panel in the display device according to the third embodiment;

FIG. 20 is a diagram illustrating the relation between the luminance of light transmitted through the second polarizing plate and the amount of shift in the X direction between the sub pixels of the first liquid crystal display panel and the sub pixels of the second liquid crystal display panel when the display device according to the third embodiment is in white display;

FIG. 21 is a diagram illustrating the relation between the luminance of light transmitted through the second polarizing plate and the amount of shift in the Y direction between the sub pixels of the first liquid crystal display panel and the sub pixels of the second liquid crystal display panel when the display device according to the third embodiment is in white display;

FIG. 22 is a diagram illustrating an arrangement of sub pixels in the first liquid crystal display panel included in a display device according to a fourth embodiment of the present disclosure;

FIG. 23 is a diagram illustrating the positional relation between the sub pixels of the first liquid crystal display panel and sub pixels of the second liquid crystal display panel in the display device according to the fourth embodiment;

FIG. 24 is a diagram illustrating the relation between the luminance of light transmitted through the second polarizing plate and the amount of shift in the X direction between the sub pixels of the first liquid crystal display panel and the sub pixels of the second liquid crystal display panel when the display device according to the fourth embodiment is in white display;

FIG. 25 is a diagram illustrating the relation between the luminance of light transmitted through the second polarizing plate and the amount of shift in the Y direction between the sub pixels of the first liquid crystal display panel and the sub pixels of the second liquid crystal display panel when the display device according to the fourth embodiment is in white display;

FIG. 26 is a diagram illustrating an arrangement of sub pixels in the first liquid crystal display panel included in a display device according to a fifth embodiment of the present disclosure;

FIG. 27 is a diagram illustrating the positional relation between the sub pixels of the first liquid crystal display panel and sub pixels of the second liquid crystal display panel in the display device according to the fifth embodiment;

FIG. 28 is a diagram illustrating the relation between the luminance of light transmitted through the second polarizing plate and the amount of shift in the X direction between the sub pixels of the first liquid crystal display panel and the sub pixels of the second liquid crystal display panel when the display device according to the fifth embodiment is in white display;

FIG. 29 is a diagram illustrating the relation between the luminance of light transmitted through the second polarizing plate and the amount of shift in the Y direction between the sub pixels of the first liquid crystal display panel and the sub pixels of the second liquid crystal display panel when the display device according to the fifth embodiment is in white display; and

FIG. 30 is a diagram illustrating the configuration of a display device according to a modification of the embodiments of the present disclosure.

### DETAILED DESCRIPTION

Embodiments of the present disclosure will be described below with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

An X direction, a Y direction, and a Z direction illustrated in the drawings are orthogonal to each other and indicate directions of a display device 1. The X direction and the Y direction correspond to side directions of the display device 1. In the X direction, the side indicated by an arrow corresponds to the positive X side, and the opposite side thereto corresponds to the negative X side. In the Y direction, the side indicated by an arrow corresponds to the positive Y side, and the opposite side thereto corresponds to the negative Y side. In the Z direction, the side indicated by an arrow corresponds to the positive Z side, and the opposite side corresponds to the negative Z side. The Z direction corresponds to the thickness direction of the display device 1. The X, Y, and Z directions are exemplary, and the present disclosure is not limited to these directions. In the present disclosure, when simply referred to as "plan view", it means viewing the display device 1 along the Z direction.

### First Embodiment

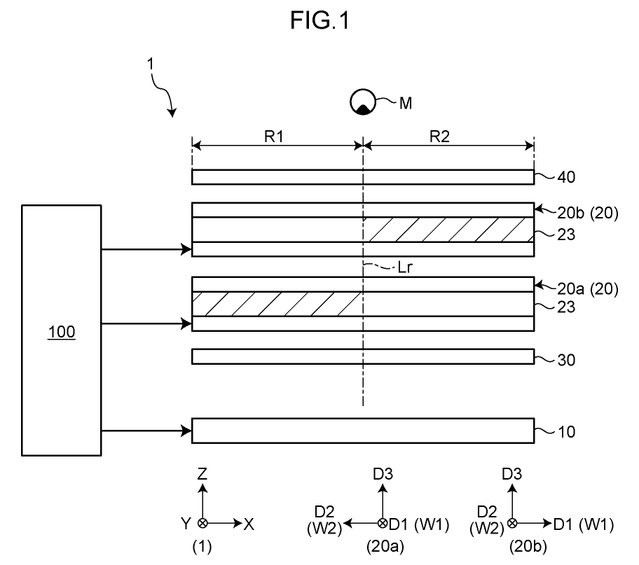

FIG. 1 is a schematic diagram illustrating the configuration of the display device 1 according to a first embodiment of the present disclosure. Examples of the display device 1 include a wristwatch-type electronic apparatus such as a smartwatch, and an instrument panel attached to a vehicle such as an automobile.

The display device 1 includes a light source device 10, a first liquid crystal display panel 20a, a second liquid crystal display panel 20b, a first polarizing plate 30, and a second polarizing plate 40. The light source device 10, the first polarizing plate 30, the first liquid crystal display panel 20a, the second liquid crystal display panel 20b, and the second polarizing plate 40 are disposed in the stated order from the negative Z side toward the positive Z side.

The light source device 10 emits light toward the first polarizing plate 30. The light source device 10 is, for example, a direct-type backlight and includes a plurality of light-emitting diodes (not illustrated). The light source device 10 is electrically coupled to an external device 100 in a wired or wireless manner, and a light emission timing, a light emission time, and the like thereof are controlled.

The first liquid crystal display panel 20a and the second liquid crystal display panel 20b are transmissive liquid crystal displays. In the first embodiment, the first liquid crystal display panel 20a and the second liquid crystal display panel 20b are similarly configured. Hereinafter, when described without distinction from each other, the first liquid crystal display panel 20a and the second liquid crystal display panel 20b are simply referred to as a liquid crystal display panel 20.

A first panel direction D1, a second panel direction D2, and a third panel direction D3 illustrated in the drawings are orthogonal to each other and indicate directions of the liquid crystal display panel 20. The first panel direction D1 and the second panel direction D2 correspond to directions parallel to a principal surface of a substrate included in the liquid crystal display panel 20. The third panel direction D3 corresponds to a direction orthogonal to the principal surface of the substrate included in the liquid crystal display panel 20. The third panel direction D3 corresponds to the thickness direction of the liquid crystal display panel 20 In the third panel direction D3, the side indicated by an arrow (positive D3 side) corresponds to a front surface side of the liquid crystal display panel 20 on which an image is displayed, and the opposite side (negative D3 side) thereto corresponds to a back surface side of the liquid crystal display panel 20. The first panel direction D1, the second panel direction D2, and the third panel direction D3 are exemplary, and the present disclosure is not limited to these directions.

The liquid crystal display panel 20 is disposed such that the third panel direction D3 and the Z direction are parallel. The liquid crystal display panel 20 is electrically coupled to the external device 100 and displays an image based on an image signal transmitted from the external device 100. The first liquid crystal display panel 20aand the second liquid crystal display panel 20b are disposed so as to be spaced apart from each other in the Z direction and overlap each other in plan view.

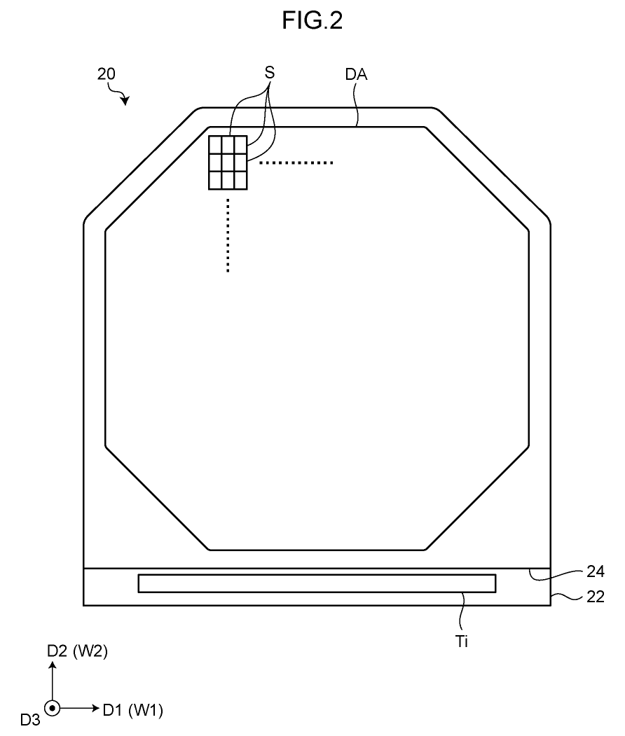

FIG. 2 is a plan view of the liquid crystal display panel 20 illustrated in FIG. 1. The front surface of the liquid crystal display panel 20 has a display region DA in which an image is displayed. The front surface of the liquid crystal display panel 20 is orthogonal to the Z direction. The display region DA has a polygonal shape in plan view, but may have a quadrilateral shape. The display region DA of the first liquid crystal display panel 20a and the display region DA of the second liquid crystal display panel 20b overlap each other in plan view.

In the display region DA, a plurality of sub pixels S are arranged in a matrix (row-column configuration) of rows in a row direction W1 and columns in a column direction W2. The row direction W1 and the column direction W2 are orthogonal to each other. The row direction W1 is parallel to the first panel direction D1, and the column direction W2 is parallel to the second panel direction D2. The sub pixels S each have a rectangular shape having a long side direction and a short side direction in plan view. The sub pixels S are disposed such that the long side direction is parallel to the column direction W2 and the short side direction is parallel to the row direction W1. Details of the disposition of the sub pixels S will be described later.

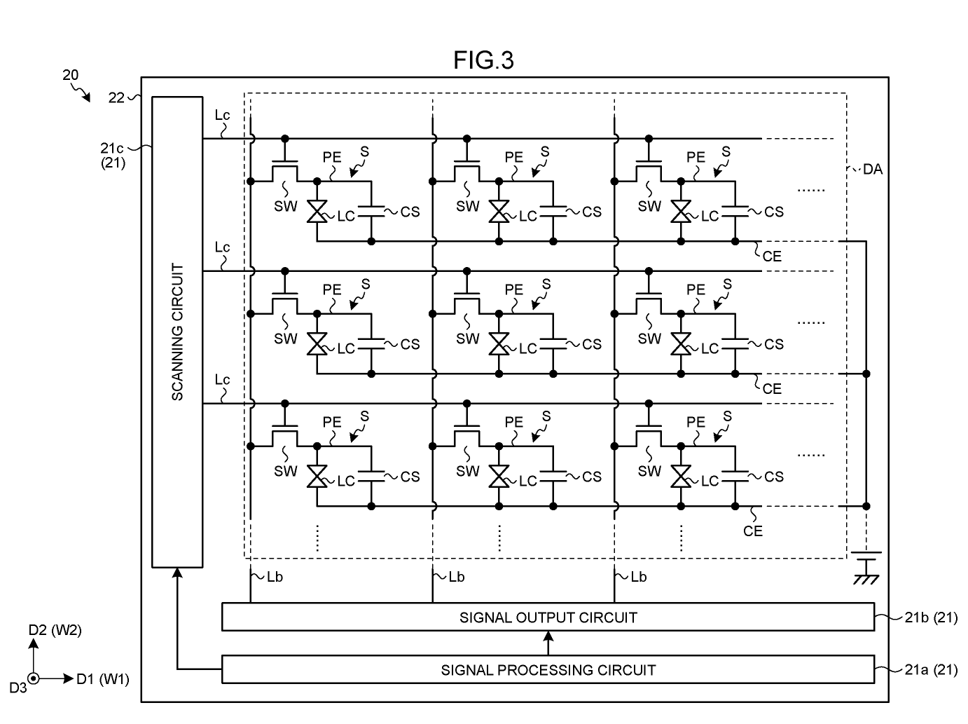

FIG. 3 is a diagram illustrating a circuit configuration of the liquid crystal display panel 20 illustrated in FIG. 2. The liquid crystal display panel 20 includes a drive circuit 21, and a switching element SW, a sub pixel electrode PE, a common electrode CE, a liquid crystal capacitor (capacitance) LC, and a storage capacitor CS provided in each of the sub pixels S.

The drive circuit 21 displays an image in the display region DA. The drive circuit 21 includes a signal processing circuit 21a, a signal output circuit 21b, and a scanning circuit 21c.

The signal processing circuit 21a generates sub pixel signals, which will be described later, based on an image signal output from the external device 100, and outputs the generated sub pixel signals to the signal output circuit 21b. The signal processing circuit 21aalso outputs a clock signal synchronizing operation of the signal output circuit 21b and operation of the scanning circuit 21c to the signal output circuit 21b and the scanning circuit 21c.

The signal output circuit 21b outputs the sub pixel signals to the corresponding sub pixels S. The signal output circuit 21bis electrically coupled to the sub pixels S through a plurality of signal lines Lb extending in the column direction W2.

The scanning circuit 21c scans the sub pixels S in synchronization with the outputting of the sub pixel signals from the signal output circuit 21b. The scanning circuit 21c is electrically coupled to the sub pixels S through a plurality of scanning lines Lc extending in the row direction W1.

In plan view, each region partitioned by two signal lines Lb adjacent to each other in the row direction W1 and two scanning lines Lc adjacent to each other in the column direction W2 corresponds to one of the sub pixels S.

The switching element SW includes, for example, a thin film transistor (TFT). The switching element SW has a source electrode electrically coupled to the signal lines Lb, and a gate electrode electrically coupled to the scanning lines Lc.

The sub pixel electrode PE is coupled to a drain electrode of the switching element SW. A plurality of the common electrodes CE are disposed corresponding to the sub pixel electrodes PE. The sub pixel electrodes PE and the common electrodes CE have a light-transmitting property.

The liquid crystal capacitor (capacitance) LC is a capacitive component of a liquid crystal material of a liquid crystal layer 23 to be described later between the sub pixel electrode PE and the common electrode CE. The storage capacitor CS is formed between an electrode at the same potential as the common electrode CE and an electrode at the same potential as the sub pixel electrode PE.

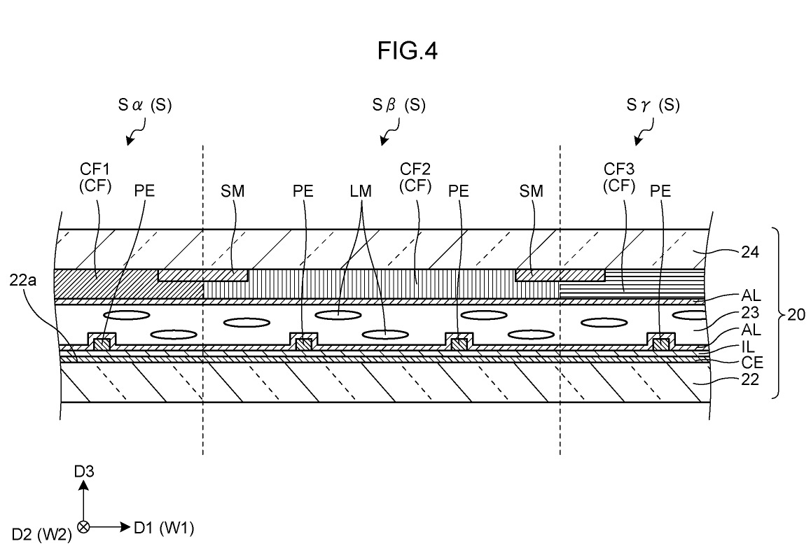

FIG. 4 is a sectional view of the liquid crystal display panel 20 illustrated in FIG. 2. The liquid crystal display panel 20 includes a first substrate 22, the liquid crystal layer 23, and a second substrate 24.

The first substrate 22, the liquid crystal layer 23, and the second substrate 24 have a light-transmitting property and are disposed in the stated order from the negative D3 side toward the positive D3 side. An IC chip Ti, which constitutes the drive circuit 21, is disposed on the first substrate 22 (FIG. 2).

The common electrode CE is disposed on a principal surface 22a corresponding to a front surface of the first substrate 22. An insulating layer IL is disposed on a front surface of the common electrode CE, and in addition, the sub pixel electrode PE and an alignment film AL are disposed thereon.

The sub pixel electrode PE is disposed between the insulating layer IL and the alignment film AL. In this manner, the common electrode CE and the sub pixel electrode PE are disposed on the first substrate 22. That is, the liquid crystal display panel 20 is a liquid crystal display of a horizontal electric field type. The signal lines Lb and the scanning lines Lc (not illustrated in FIG. 4) are disposed on the principal surface 22a of the first substrate 22.

The second substrate 24 is positioned on the positive D3 side of the first substrate 22. First color filters CF1, second color filters CF2, and third color filters CF3, which are different in color, a light-shielding film SM, and an alignment film AL are disposed on a back surface of the second substrate 24. The light-shielding film SM and the color filters CF are disposed between the second substrate 24 and the alignment film AL. Hereinafter, the first color filters CF1, the second color filters CF2, and the third color filters CF3 are simply referred to as the color filters CF when they are described without distinction between them.

Each color filter CF has a quadrilateral shape in plan view. The color filters CF has a light-transmitting property and has a predetermined peak of the spectrum of light to be transmitted. The spectrum peak corresponds to the color of a corresponding one of the color filters CF. The color of the first color filters CF1 is red, the color of the second color filters CF2 is green, and the color of the third color filters CF3 is blue.

Each sub pixel S has one color filter CF. A sub pixel S having a first color filter CF1 is referred to as a first sub pixel Sα, a sub pixel S having a second color filter CF2 is referred to as a second sub pixel Sβ, and a sub pixel S having a third color filter CF3 is referred to as a third sub pixel Sγ. That is, the first sub pixel Sα is a red sub pixel S, the second sub pixel Sβ is a green sub pixel S, and the third sub pixel Sγ is a blue sub pixel S. The first sub pixel Sα, the second sub pixel Sβ, and the third sub pixel Sγ are simply referred to as the sub pixels S When they are described without distinction between them.

The light-shielding film SM has a light-blocking property. The light-shielding film SM overlaps the signal lines Lb and the scanning lines Lc in the third panel direction D3. That is, the light-shielding film SM partitions the sub pixels S. In other words, in the third panel direction D3, the light-shielding film SM overlaps the boundary of two sub pixels S adjacent to each other in the row direction W1 and the column direction W2.

The liquid crystal layer 23 contains a plurality of liquid crystal molecules LM. The liquid crystal layer 23 is disposed between the two alignment films AL facing each other in the third panel direction D3. Alignment of the liquid crystal molecules LM is regulated by the two alignment films AL.

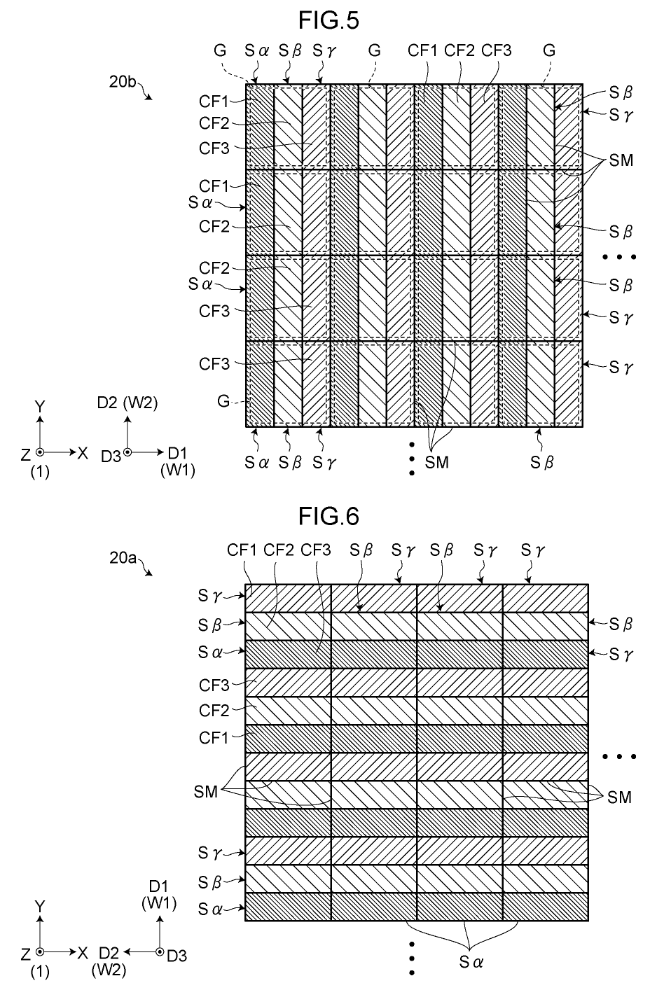

FIG. 5 is a diagram illustrating an arrangement of the sub pixels S of the second liquid crystal display panel 20b illustrated in FIG. 1. The sub pixels S illustrated in the diagram are indicated by the color filters CF and the light-shielding film SM. In a plan view of the liquid crystal display panel 20, the sub pixels S are partitioned by the light-shielding film SM, and the color filters CF have quadrilateral shapes. As described above, each first sub pixel Sα includes a red first color filter CF1, each second sub pixel Sβ includes a green second color filter CF2, and each third sub pixel Sγ includes a blue third color filter CF3.

The arrangement of the sub pixels S of the second liquid crystal display panel 20b is a so-called stripe arrangement. Specifically, the sub pixels S are disposed such that: the first sub pixel Sα, the second sub pixel Sβ, and the third sub pixel Sγ are repeatedly arranged in the stated order in the row direction W1; the first sub pixels Sα are continuously arranged in the column direction W2; the second sub pixels Sβ are continuously arranged in the column direction W2; and the third sub pixels Sγ are continuously arranged in the column direction W2.

Each of a plurality of pixels G constituting an image is made up of one first sub pixel Sα, one second sub pixel Sβ, and one third sub pixel Sγ that are continuously arranged in the row direction W1. Each pixel G has a square shape in a plan view of the liquid crystal display panel 20. The pixels G are arranged in a matrix (row-column configuration) of rows and columns along the row direction W1 and the column direction W2.

The second liquid crystal display panel 20b is disposed in the display device 1 such that the row direction W1 (first panel direction D1) aligns with the X direction (corresponding to a "second direction") and the column direction W2 (second panel direction D2) aligns with the Y direction (corresponding to a "first direction" in the first embodiment) (refer to FIGS. 1 and 5).

FIG. 6 is a diagram illustrating an arrangement of the sub pixels S of the first liquid crystal display panel 20a illustrated in FIG. 1. Each sub pixel S of the first liquid crystal display panel 20a and each sub pixel S of the second liquid crystal display panel 20b have the same shape and the same size in plan view. Similarly to the second liquid crystal display panel 20b, the arrangement of the sub pixels S of the first liquid crystal display panel 20a is a stripe arrangement.

The first liquid crystal display panel 20a is disposed in the display device 1 such that the row direction W1 (first panel direction D1) aligns with the Y direction and the column direction W2 (second panel direction D2) aligns with the X direction (refer to FIGS. 1 and 6). Accordingly, the row direction W1 of the first liquid crystal display panel 20a and the row direction W1 of the second liquid crystal display panel 20b form an angle of 90°.

Light from the light source device 10 is incident on the first polarizing plate 30 illustrated in FIG. 1. The first polarizing plate 30 transmits linearly-polarized light polarized along a first polarization direction. The first polarization direction is orthogonal to the Z direction. The light transmitted through the first polarizing plate 30 is linearly-polarized light along the first polarization direction. The light transmitted through the first polarizing plate 30 is incident on the first liquid crystal display panel 20a.

The light transmitted through the second liquid crystal display panel 20b is incident on the second polarizing plate 40. The second polarizing plate 40 transmits linearly-polarized light polarized along a second polarization direction different from the first polarization direction. The second polarization direction is orthogonal to the Z direction and the first polarization direction. The light transmitted through the second polarizing plate 40 (in other words, light transmitted through the first polarizing plate 30, the first liquid crystal display panel 20a, the second liquid crystal display panel 20b, and the second polarizing plate 40; the same applies to the following description) is linearly-polarized light along the second polarization direction. The light transmitted through the second polarizing plate 40 is visually recognized by a user M of the display device 1.

No polarizing plate is disposed between the first liquid crystal display panel 20a and the second liquid crystal display panel 20b. With the display device 1 configured in this manner, the user M can visually recognize an image displayed on the first liquid crystal display panel 20a when no voltage is applied to the second liquid crystal display panel 20b, and can visually recognize an image displayed on the second liquid crystal display panel 20b when no voltage is applied to the first liquid crystal display panel 20a (to be described later in detail).

The following describes operation of the display device 1. The description will be first made on a case where the display mode of the liquid crystal display panel 20 is a so-called normally black mode, no image signal is transmitted from the external device 100 to the display device 1, and the display device 1 displays black. In this case, in both the first liquid crystal display panel 20a and the second liquid crystal display panel 20b, the drive circuit 21 applies no voltage to the sub pixels S, and no electric field is generated in the liquid crystal layer 23. Accordingly, the alignment of the liquid crystal molecules LM is regulated to the initial alignment (horizontal alignment; direction orthogonal to the Z direction) by the alignment films AL.

Light from the light source device 10 is incident on the first polarizing plate 30. The light transmitted through the first polarizing plate 30 is incident on the liquid crystal layer 23 of the first liquid crystal display panel 20a.

When the alignment of the liquid crystal molecules LM is regulated to the initial alignment by the alignment films AL, the polarization axis of light passing through the liquid crystal layer 23 is not rotated. Light transmitted through the liquid crystal layer 23 of the first liquid crystal display panel 20a is transmitted through the first liquid crystal display panel 20a while maintaining the first polarization direction, and is incident on the second liquid crystal display panel 20b.

Also in the liquid crystal layer 23 of the second liquid crystal display panel 20b, similarly to the liquid crystal layer 23 of the first liquid crystal display panel 20a, the polarization axis of light passing through the liquid crystal layer 23 does not rotate. Light transmitted through the liquid crystal layer 23 of the second liquid crystal display panel 20b is transmitted through the second liquid crystal display panel 20b while maintaining the first polarization direction, and is incident on the second polarizing plate 40.

The first polarization direction of the light passing through the second liquid crystal display panel 20b is orthogonal to the second polarization direction of the second polarizing plate 40. Accordingly, the light transmitted through the second liquid crystal display panel 20b does not pass through the second polarizing plate 40. As a result, the user M visually recognizes black.

The following describes operation in which the liquid crystal display panel 20 displays an image in the display region DA. The drive circuit 21 generates sub pixel signals based on an image signal transmitted from the external device 100, and outputs the sub pixel signals to the sub pixels S through the signal output circuit 21b. The sub pixel signals include sub gradation data indicating the gradation levels of the sub pixels S.

In addition, as the sub pixels S are scanned by the scanning circuit 21c, the switching elements SW are operated, and the sub pixel signals are transmitted to the sub pixel electrodes PE. Accordingly, potential difference occurs between the common electrodes CE and the sub pixel electrodes PE, and electric field is generated in the liquid crystal layer 23. As a result, the alignment of the liquid crystal molecules LM changes. The alignment of the liquid crystal molecules LM depends on the sub gradation data. Accordingly, light passing through the liquid crystal layer 23 is modulated for each sub pixel S. Light transmitted through the color filters CF has the colors of the color filters CF. In this manner, the luminance and color of light passing through the liquid crystal display panel 20 are adjusted for each sub pixel S, and accordingly, an image is displayed in the display region DA.

The following describes a case where the user M visually recognizes a first image displayed on the first liquid crystal display panel 20a and visually recognizes a second image displayed on the second liquid crystal display panel 20b.

For simplification of description, the description will be made on a case where the first image is visually recognized in a first region R1 on the negative X side of a boundary line Lr in the display device 1 illustrated in FIG. 1, and the second image is visually recognized in a second region R2 on the positive X side of the boundary line Lr.

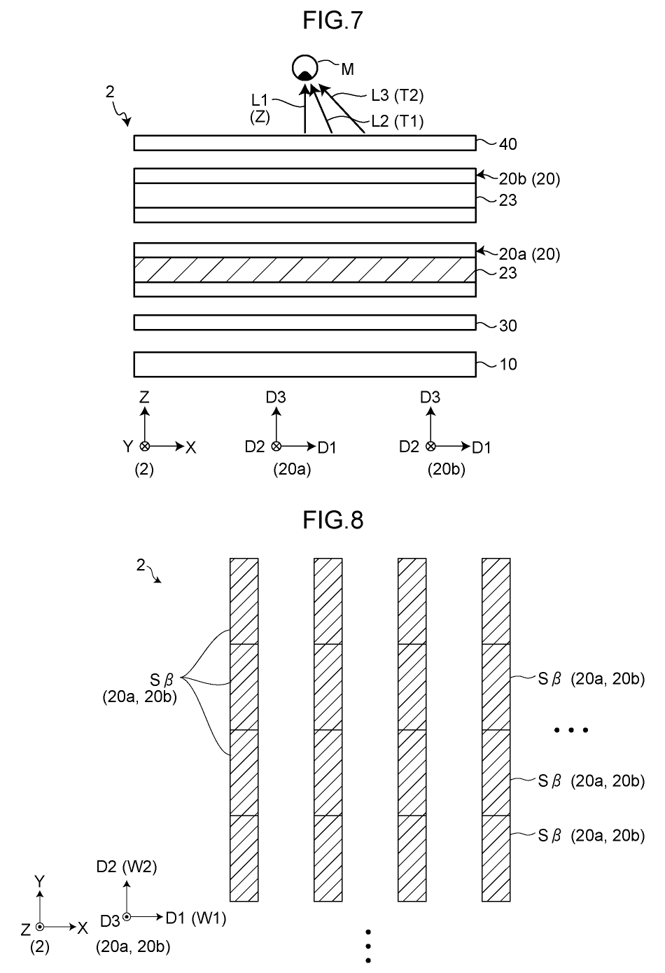

An image signal including information of the first image is transmitted to the first liquid crystal display panel 20a. In the first liquid crystal display panel 20a, in accordance with sub pixel signals generated based on the image signal, voltage is applied to the sub pixels S corresponding to the first region R1, and no voltage is applied to the sub pixels S corresponding to the second region R2. The hatched part of each liquid crystal layer 23 in FIG. 1 indicates that voltage is applied to the sub pixels S, and the non-hatched part of each liquid crystal layer 23 indicates that no voltage is applied to the sub pixels S (the same applies to FIG. 7 to be described later).

An image signal including information of the second image is transmitted to the second liquid crystal display panel 20b. In the second liquid crystal display panel 20b, in accordance with sub pixel signals generated based on the image signal, no voltage is applied to the sub pixels S corresponding to the first region R1, and voltage is applied to the sub pixels S corresponding to the second region R2.

In the first region R1, light passing through the first liquid crystal display panel 20a is modulated, and accordingly, the first image is displayed in the display region DA of the first liquid crystal display panel 20a. The light transmitted through the first liquid crystal display panel 20a is also incident on the second liquid crystal display panel 20b. No voltage is applied to the sub pixels S in the second liquid crystal display panel 20b, and the light passing through the second liquid crystal display panel 20b is not modulated. As a result, the light transmitted through the second polarizing plate 40 in the first region R1 is visually recognized as the first image by the user M.

In the second region R2, no voltage is applied to the sub pixels S in the first liquid crystal display panel 20a, and light passing through the first liquid crystal display panel 20a is not modulated. The light transmitted through the first liquid crystal display panel 20a is also incident on the second liquid crystal display panel 20b. In the second region R2, the light passing through the second liquid crystal display panel 20b is modulated, and accordingly, the second image is displayed in the display region DA of the second liquid crystal display panel 20b. As a result, the light transmitted through the second polarizing plate 40 in the second region R2 is visually recognized as the second image by the user M. The first region R1 and the second region R2 are not limited to the example illustrated in FIG. 1, but are changed depending on the shapes, sizes, and extents of the first image and the second image.

As described above, the first liquid crystal display panel 20a and the second liquid crystal display panel 20b are disposed in a state of being spaced apart from each other in the Z direction. Accordingly, the user M visually recognizes a stereoscopic image composed of the first image and the second image. However, as described below, so-called moire may occur depending on the disposition of the first liquid crystal display panel 20a and the second liquid crystal display panel 20b.

FIG. 7 is a schematic diagram of a display device 2 according to a comparative example for illustrating moire. Similarly to the above-described display device 1, the display device 2 according to the comparative example includes the light source device 10, the first polarizing plate 30, the first liquid crystal display panel 20a, the second liquid crystal display panel 20b, and the second polarizing plate 40.

The display device 2 according to the comparative example is different from the above-described display device 1 in the orientation of the first liquid crystal display panel 20a. In the display device 2 according to the comparative example, similarly to the second liquid crystal display panel 20b, the first liquid crystal display panel 20a is disposed in the display device 2 such that the row direction W1 (first panel direction D1) aligns with the X direction and the column direction W2 (second panel direction D2) aligns with the Y direction. Accordingly, the row direction W1 of the first liquid crystal display panel 20a and the row direction W1 of the second liquid crystal display panel 20b are parallel to the X direction and parallel to each other. The periphery of each sub pixel S of the first liquid crystal display panel 20a and the periphery of the corresponding sub pixel S of the second liquid crystal display panel 20b overlap each other in plan view.

A white display state refers to a state in which voltage is applied to the sub pixels S of the first liquid crystal display panel 20a so that a white image is displayed on the entire display region DA of the first liquid crystal display panel 20a, and no voltage is applied to the sub pixels S of the second liquid crystal display panel 20b, and whereby, the display device 1 causes a white image to be visually recognized by the user M. When the display device 1 is in the white display state, the luminance of transmitted light is substantially the same for all the sub pixels S in the first liquid crystal display panel 20a. The display device 2 according to the comparative example illustrated in FIG. 7 is in the white display state.

First light L1, second light L2, and third light L3 illustrated in FIG. 7 are each transmitted light through the second polarizing plate 40. The first light L1 travels toward the user M in the Z direction. The second light L2 travels toward the user M in a first tilted direction T1 tilted relative to the Z direction and the X direction. The third light L3 travels toward the user M in a second tilted direction T2 tilted relative to the Z direction and the X direction by a larger amount than the first tilted direction T1. In this case, as described below, the sub pixels S of the same color are different in luminance between the first light L1, the second light L2, and the third light L3.

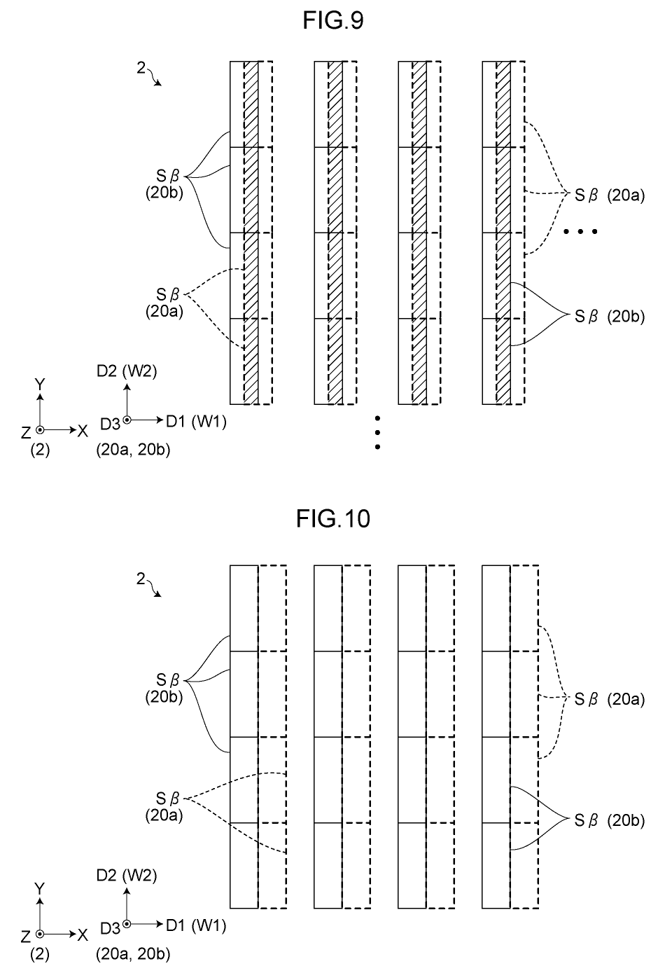

FIG. 8 is a diagram illustrating an array of the sub pixels S of the first liquid crystal display panel 20a and an array of the sub pixels S of the second liquid crystal display panel 20b when the display device 2 according to the comparative example illustrated in FIG. 7 is viewed along the Z direction by the user M. In FIG. 8, only the second sub pixels Sβ among the sub pixels S are illustrated (the same applies to FIGS. 9 and 10 to be described later).

As described above, the periphery of each sub pixel S of the first liquid crystal display panel 20a and the periphery of the corresponding sub pixel S of the second liquid crystal display panel 20b overlap each other in plan view. Accordingly, a portion (hatched portion) where each second sub pixel Sβ of the first liquid crystal display panel 20a and the corresponding second sub pixel Sβ of the second liquid crystal display panel 20b overlap each other as viewed in the Z direction extends across all the second sub pixels Sβ. As a result, light transmitted through the second sub pixel Sβ of the first liquid crystal display panel 20a in the Z direction is substantially transmitted through the second sub pixel Sβ of the second liquid crystal display panel 20b.

FIG. 9 is a diagram illustrating the array of the sub pixels S of the first liquid crystal display panel 20a and the array of the sub pixels S of the second liquid crystal display panel 20b when the display device 2 according to the comparative example illustrated in FIG. 7 is viewed along the first tilted direction T1 by the user M. In FIG. 9, the second sub pixels Sβ of the first liquid crystal display panel 20a are illustrated with dashed lines, and the second sub pixels Sβ of the second liquid crystal display panel 20b are illustrated with solid lines (the same applies to FIG. 10 to be described later).

As illustrated in FIG. 9, each sub pixel S of the second liquid crystal display panel 20b is shifted in the X direction by half of the short side length of the sub pixel S relative to the corresponding sub pixel S of the first liquid crystal display panel 20a. Accordingly, as for the second sub pixels Sβ, a portion (hatched portion) where each second sub pixel Sβ of the first liquid crystal display panel 20a and the corresponding second sub pixel Sβ of the second liquid crystal display panel 20b overlap each other in the first tilted direction T1 corresponds to half of the second sub pixel Sβ. As a result, part of light transmitted through the second sub pixel Sβ of the first liquid crystal display panel 20a in the first tilted direction T1 is transmitted through the second sub pixel Sβ of the second liquid crystal display panel 20b in the first tilted direction T1. That is, as for the luminance of transmitted light from the second sub pixels Sβ, the second light L2 is lower than the first light L1. This also applies to the first sub pixels Sα and the third sub pixels Sγ.

FIG. 10 is a diagram illustrating the array of the sub pixels S of the first liquid crystal display panel 20a and the array of the sub pixels S of the second liquid crystal display panel 20b when the display device 2 according to the comparative example illustrated in FIG. 7 is viewed along the second tilted direction T2 by the user M.

As illustrated in FIG. 10, each sub pixel S of the second liquid crystal display panel 20b is shifted in the X direction by the short side length of the sub pixel S relative to the corresponding sub pixel S of the first liquid crystal display panel 20a. Accordingly, each second sub pixel Sβ of the first liquid crystal display panel 20a and the corresponding second sub pixel Sβ of the second liquid crystal display panel 20b do not overlap each other in the second tilted direction T2. As a result, substantially all of light transmitted through the second sub pixel Sβ of the first liquid crystal display panel 20a in the second tilted direction T2 is not transmitted through the second sub pixel Sβ of the second liquid crystal display panel 20b in the second tilted direction T2. That is, as for the luminance of transmitted light from the second sub pixels Sβ, the third light L3 is lower than the second light L2. This also applies to the first sub pixels Sα and the third sub pixels Sγ.

In this manner, the luminance of the sub pixels S of the same color decreases in the order of the first light L1, the second light L2, and the third light L3. Accordingly, the luminance of the sub pixels S of the same color changes depending on the tilt degree of light visually recognized by the user M. In other words, the luminance of the sub pixels S of the same color changes also when the sub pixels S of the first liquid crystal display panel 20a and the sub pixels S of the second liquid crystal display panel 20b are shifted from each other in the X direction.

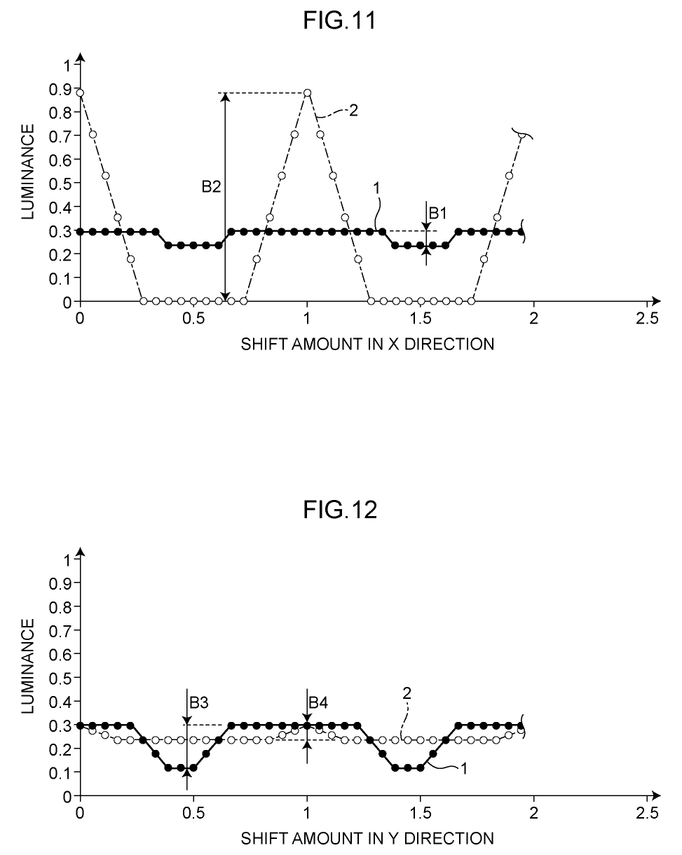

FIG. 11 is a diagram illustrating the relation between the luminance of light transmitted through the second polarizing plate 40 and the amount of shift in the X direction between the sub pixels S of the first liquid crystal display panel 20a and the sub pixels S of the second liquid crystal display panel 20b when the display devices 1 and 2 are in the white display state.

The horizontal axis illustrated in the diagram represents the amount of shift of the sub pixels S. The amount of shift of the sub pixels S corresponds to the amount of shift of the pixels G, and the amount of shift by one pixel G corresponds to 1. The vertical axis illustrated in the diagram represents the luminance of light transmitted through the second polarizing plate 40 (hereinafter also simply referred to as luminance). The vertical axis in FIG. 11 represents the luminance per one sub pixel S. The luminance of one sub pixel S when all of light transmitted through the one sub pixel S of the first liquid crystal display panel 20a passes through the second liquid crystal display panel 20b is defined as 1 (the same applies to FIGS. 12, 16, and 17 to be described later).

In FIG. 11, the luminance corresponding to the amount of shift of the sub pixels S in the X direction in the display device 2 according to the comparative example is illustrated with dashed and single-dotted lines. The luminance corresponding to the amount of shift of the sub pixels S in the X direction periodically varies. This is due to the sub pixel arrangement in which the first sub pixel Sα, the second sub pixel Sβ, and the third sub pixel Sγ are repeatedly arranged in the stated order in the X direction.

FIG. 12 is a diagram illustrating the relation between the luminance of light transmitted through the second polarizing plate 40 and the amount of shift in the Y direction between the sub pixels S of the first liquid crystal display panel 20a and the sub pixels S of the second liquid crystal display panel 20b when the display device 1 in FIG. 1 and the display device 2 according to the comparative example are in the white display state.

In FIG. 12, the luminance corresponding to the amount of shift of the sub pixels S in the Y direction in the display device 2 according to the comparative example is illustrated with dashed and single-dotted lines. The luminance corresponding to the amount of shift of the sub pixels S in the Y direction periodically varies. In the display device 2 according to the comparative example, the variation range of the luminance in FIG. 12 is smaller than the variation range of the luminance in FIG. 11. This is due to the continuous arrangement of the sub pixels S of the same color in the Y direction. In the display device 2 according to the comparative example, when the sub pixels S of the first liquid crystal display panel 20a and the sub pixels S of the second liquid crystal display panel 20b are shifted from each other in the Y direction, and the sub pixels S span the light-shielding film SM, the luminance decreases.

As described above, change in the amount of shift of the sub pixels S means change in the tilt degree of light transmitted through the second polarizing plate 40 toward the user M. The luminance corresponding to the amount of shift of the sub pixels S periodically varies. Accordingly, since the luminance of light transmitted through the second polarizing plate 40 periodically varies with the tilt degree of light transmitted through the second polarizing plate 40 toward the user M, moire in which the user M visually recognizes a striped pattern may occur. Thus, in the display device 1 according to the first embodiment, the arrangement of the sub pixels S in the first liquid crystal display panel 20a and the second liquid crystal display panel 20b is determined as described above (FIGS. 5 and 6).

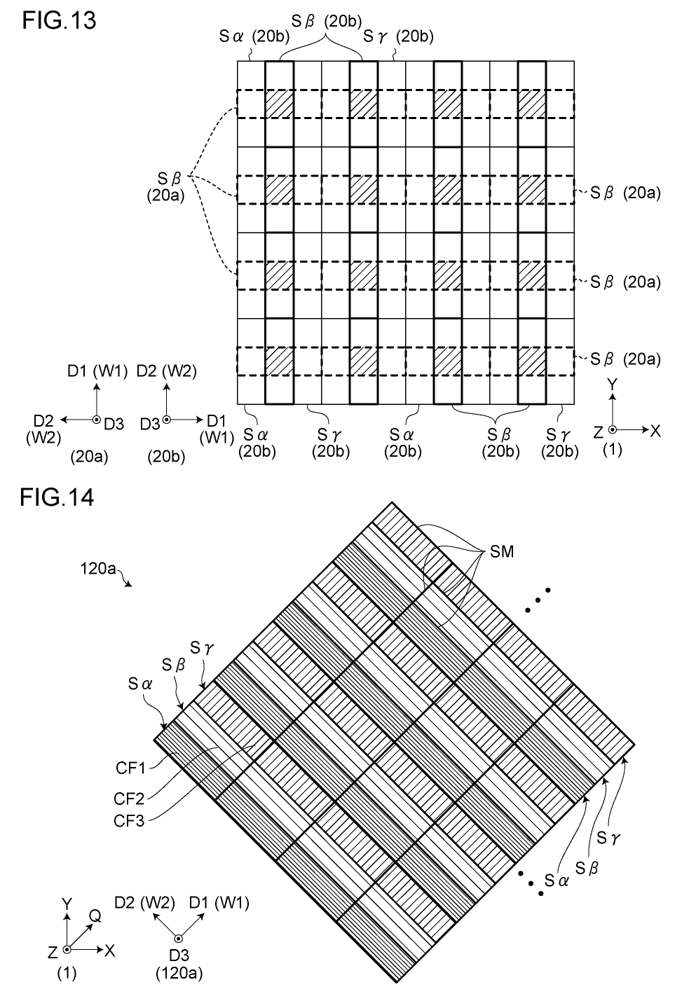

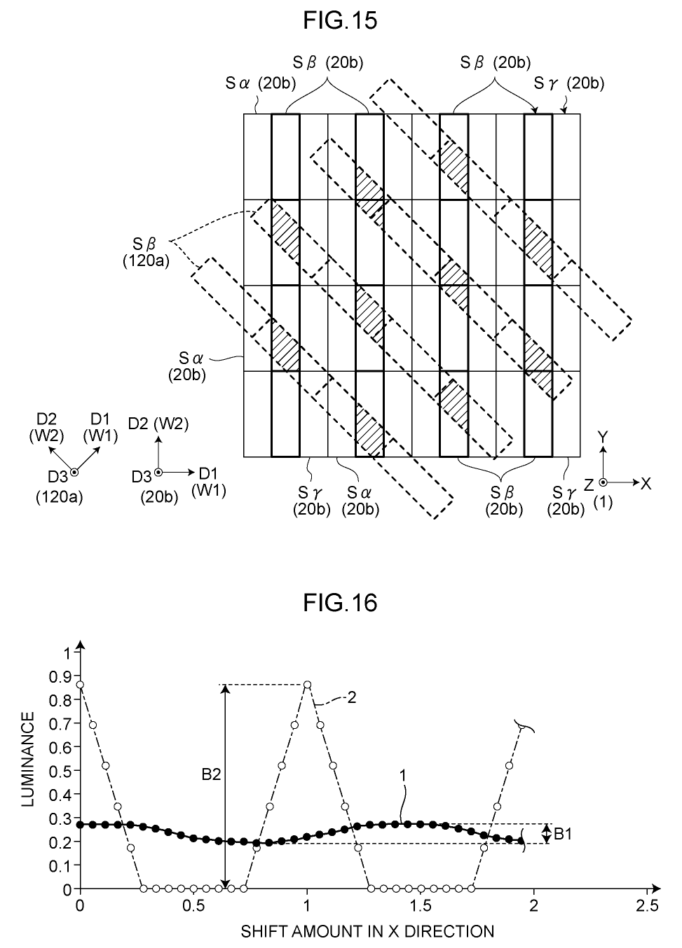

FIG. 13 is a diagram illustrating the positional relation between the sub pixels S of the first liquid crystal display panel 20a and the sub pixels S of the second liquid crystal display panel 20b in the display device 1 in FIG. 1. In FIG. 13, only the second sub pixels Sβ of the first liquid crystal display panel 20a are illustrated with dashed lines. In the second liquid crystal display panel 20b, the second sub pixels Sβ are illustrated with thick solid lines, and the first sub pixels Sα and the third sub pixels Sγ are illustrated with thin solid lines (the same applies to FIGS. 15, 19, 23, and 27 to be described later).

In the display device 1, as described above, the first liquid crystal display panel 20a and the second liquid crystal display panel 20b are disposed such that the row direction W1 of the first liquid crystal display panel 20a and the row direction W1 of the second liquid crystal display panel 20b form an angle of 90°.

As for the second sub pixels Sβ, a portion (hatched portion) where each second sub pixel Sβ of the first liquid crystal display panel 20a and the corresponding second sub pixel Sβ of the second liquid crystal display panel 20b overlap each other in plan view corresponds to part of the second sub pixel Sβ. In plan view, the second sub pixels Sβ of the first liquid crystal display panel 20a overlap both the first sub pixels Sα and the third sub pixels Sγ of the second liquid crystal display panel 20b. Accordingly, in plan view, the second color filters CF2 of the first liquid crystal display panel 20a overlap the first color filters CF1, the second color filters CF2, and the third color filters CF3 of the second liquid crystal display panel 20b.

Similarly, a portion where each first sub pixel Sα of the first liquid crystal display panel 20a and the corresponding first sub pixel Sα of the second liquid crystal display panel 20b overlap each other in plan view corresponds to part of the first sub pixel Sα. In plan view, the first sub pixels Sα of the first liquid crystal display panel 20a overlap both the second sub pixels Sβ and the third sub pixels Sγ of the second liquid crystal display panel 20b. Accordingly, in plan view, the first color filters CF1 of the first liquid crystal display panel 20a overlap the first color filters CF1, the second color filters CF2, and the third color filters CF3 of the second liquid crystal display panel 20b.

Similarly, a portion where each third sub pixel Sγ of the first liquid crystal display panel 20a and the corresponding third sub pixel Sγ of the second liquid crystal display panel 20b overlap each other in plan view corresponds to part of the third sub pixel Sγ. In plan view, the third sub pixels Sγ of the first liquid crystal display panel 20a overlap both the first sub pixels Sα and the second sub pixels Sβ of the second liquid crystal display panel 20b. Accordingly, in plan view, the third color filters CF3 of the first liquid crystal display panel 20a overlap the first color filters CF1, the second color filters CF2, and the third color filters CF3 of the second liquid crystal display panel 20b.

In this manner, in the display device 1, the first liquid crystal display panel 20a and the second liquid crystal display panel 20b are disposed such that at least the first color filters CF1 of the first liquid crystal display panel 20a and the second color filters CF2 of the second liquid crystal display panel 20b overlap each other in plan view.

The following describes occurrence of moire when the display device 1 is in the white display state.

In FIG. 11, the relation between the amount of shift of the sub pixels S in the X direction in the display device 1 and the luminance is illustrated with solid lines. The luminance corresponding to the amount of shift of the sub pixels S in the X direction in the display device 1 periodically varies, similarly to the display device 2 according to the comparative example. However, as for the variation range of the luminance in FIG. 11, a variation range B1 of the display device 1 is smaller than a variation range B2 of the display device 2 according to the comparative example. Accordingly, in the display device 1, as compared to the display device 2 according to the comparative example, variation in the luminance due to shift between the sub pixels S in the X direction is reduced, and thus occurrence of moire can be reduced.

In FIG. 12, the relation between the amount of shift of the sub pixels S in the Y direction in the display device 1 and the luminance is illustrated with solid lines. The luminance corresponding to the amount of shift of the sub pixels S in the Y direction in the display device 1 periodically varies, similarly to the display device 2 according to the comparative example. As for the variation range of the luminance in FIG. 12, a variation range B3 of the display device 1 is larger than a variation range B4 of the display device 2 according to the comparative example.

However, the degree of reduction of the variation range B1 of the display device 1 relative to the variation range B2 of the display device 2 according to the comparative example illustrated in FIG. 11 is greater than the degree of increase of the variation range B3 of the display device 1 relative to the variation range B4 of the display device 2 according to the comparative example illustrated in FIG. 12. Thus, the display device 1 can reduce occurrence of moire as compared to the display device 2 according to the comparative example.

The orientation of the liquid crystal display panel 20 in the display device 1 and the arrangement direction of the sub pixels S in the liquid crystal display panel 20 may be changed such that the row direction W1 of the first liquid crystal display panel 20a and the row direction W1 of the second liquid crystal display panel 20b form an angle of 90°. For example, in the first liquid crystal display panel 20a, the sub pixels S may be arranged such that the row direction W1 aligns with the second panel direction D2 and the column direction W2 aligns with the first panel direction D1. In this case, the first liquid crystal display panel 20a is disposed in the display device 1 such that the row direction W1 (second panel direction D2) aligns with the Y direction and the column direction W2 (first panel direction D1) aligns with the X direction.

### Second Embodiment

The following describes the display device 1 according to a second embodiment of the present disclosure with focus on differences from the display device 1 according to the above-described first embodiment.

FIG. 14 is a diagram illustrating an arrangement of the sub pixels S of a first liquid crystal display panel 120a included in the display device 1 according to the second embodiment of the present disclosure.

The first liquid crystal display panel 120a according to the second embodiment is disposed in the display device 1 such that the row direction W1 (first panel direction D1) aligns with a Q direction (corresponding to the "first direction" in the second embodiment). The Q direction is orthogonal to the Z direction and tilted relative to the X direction and the Y direction. The Q direction and the X direction form an angle of 45°. The arrangement of the sub pixels S in the second liquid crystal display panel 20b according to the second embodiment is the same as the arrangement of the sub pixels S illustrated in FIG. 5. Thus, the row direction W1 of the first liquid crystal display panel 120a and the row direction W1 of the second liquid crystal display panel 20b form an angle of 45°.

FIG. 15 is a diagram illustrating the positional relation between the sub pixels S of the first liquid crystal display panel 120a and the sub pixels S of the second liquid crystal display panel 20b in the display device 1 according to the second embodiment. A portion where each second sub pixel Sβ of the first liquid crystal display panel 120a and the corresponding second sub pixel Sβ of the second liquid crystal display panel 20b overlap each other as viewed in the Z direction is hatched.

The second sub pixels Sβ of the first liquid crystal display panel 120a overlap the first sub pixels Sα, the second sub pixels Sβ, and the third sub pixels Sγ of the second liquid crystal display panel 20b. Accordingly, in plan view, the second color filters CF2 of the first liquid crystal display panel 120a overlap the first color filters CF1, the second color filters CF2, and the third color filters CF3 of the second liquid crystal display panel 20b.

Similarly, in plan view, both the first color filters CF1 and the third color filters CF3 of the first liquid crystal display panel 120a overlap the first color filters CF1, the second color filters CF2, and the third color filters CF3 of the second liquid crystal display panel 20b.

FIG. 16 is a diagram illustrating the relation between the luminance of light transmitted through the second polarizing plate 40 and the amount of shift in the X direction between the sub pixels S of the first liquid crystal display panel 120a and the sub pixels S of the second liquid crystal display panel 20b when the display device 1 according to the second embodiment is in white display.

The luminance corresponding to the amount of shift of the sub pixels S in the X direction in the display device 1 according to the second embodiment periodically varies, similarly to the display device 2 according to the comparative example. However, as for the variation range of the luminance in FIG. 16, the variation range B1 of the display device 1 according to the second embodiment is smaller than the variation range B2 of the display device 2 according to the comparative example. Accordingly, in the display device 1 according to the second embodiment, as compared to the display device 2 according to the comparative example, variation in the luminance due to shift between the sub pixels S in the X direction is reduced, and thus occurrence of moire can be reduced.

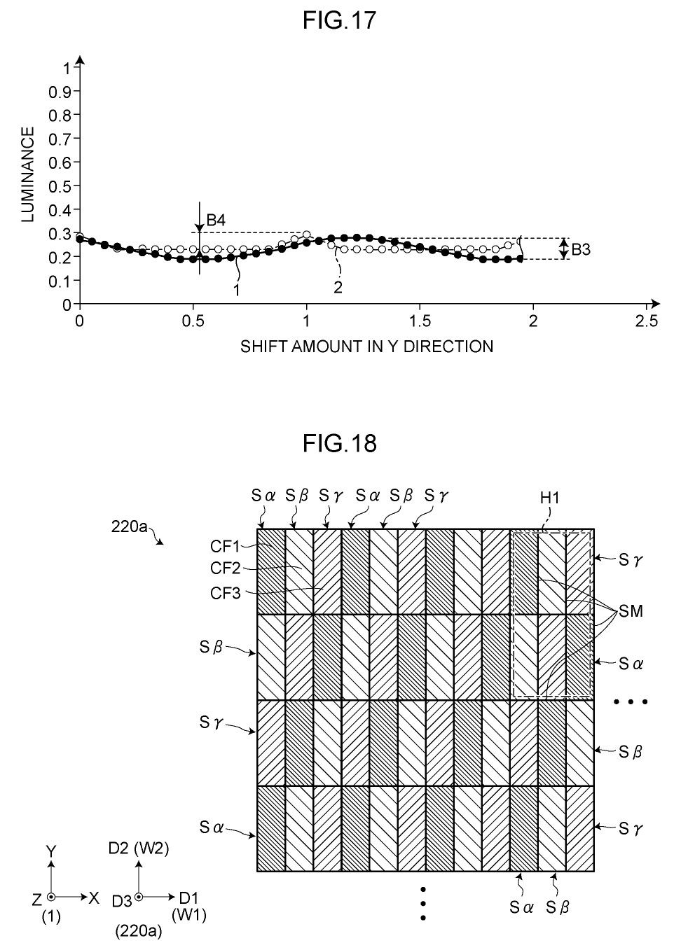

FIG. 17 is a diagram illustrating the relation between the luminance of light transmitted through the second polarizing plate 40 and the amount of shift in the Y direction between the sub pixels S of the first liquid crystal display panel 120a and the sub pixels S of the second liquid crystal display panel 20b when the display device 1 according to the second embodiment is in white display.

The luminance corresponding to the amount of shift of the sub pixels S in the Y direction in the display device 1 according to the second embodiment periodically varies, similarly to the display device 2 according to the comparative example. As for the variation range of the luminance in FIG. 17, the variation range B3 of the display device 1 according to the second embodiment is larger than the variation range B4 of the display device 2 according to the comparative example.

However, the degree of reduction of the variation range B1 of the display device 1 relative to the variation range B2 of the display device 2 according to the comparative example illustrated in FIG. 16 is greater than the degree of increase of the variation range B3 of the display device 1 relative to the variation range B4 of the display device 2 according to the comparative example illustrated in FIG. 17. Thus, the display device 1 according to the second embodiment can reduce occurrence of moire as compared to the display device 2 according to the comparative example.

The orientation of the liquid crystal display panel 20 in the display device 1 and the direction of the arrangement of the sub pixels S in the liquid crystal display panel 20 may be changed such that the row direction W1 of the first liquid crystal display panel 120a and the row direction W1 of the second liquid crystal display panel 20b form an angle of 45°. For example, in the first liquid crystal display panel 120a, the sub pixels S may be disposed such that the row direction W1 aligns with the second panel direction D2 and the column direction W2 aligns with the first panel direction D1. In this case, the first liquid crystal display panel 120a is disposed in the display device 1 such that the row direction W1 (second panel direction D2) aligns with the Q direction and the column direction W2 (first panel direction D1) aligns with a direction orthogonal to the Q direction and the Z direction.

In the display device 1 according to the second embodiment, the angle formed by the Q direction and the Y direction is not limited to 45°.

### Third Embodiment

The following describes the display device 1 according to a third embodiment of the present disclosure with focus on differences from the display device 1 according to the above-described first embodiment.

FIG. 18 is a diagram illustrating an arrangement of the sub pixels S in a first liquid crystal display panel 220a included in the display device 1 according to the third embodiment of the present disclosure. Each sub pixel S of the first liquid crystal display panel 220a and each sub pixel S of the second liquid crystal display panel 20b have the same shape and the same size in plan view. In the first liquid crystal display panel 220a according to the third embodiment, as well, three sub pixels S continuously arranged in the row direction W1 correspond to one pixel G.

The sub pixels S in the first liquid crystal display panel 220a are disposed such that the first sub pixel Sα, the second sub pixel Sβ, and the third sub pixel Sγ are repeatedly arranged in the stated order in each of the row direction W1 and the column direction W2.

The first liquid crystal display panel 220a is disposed in the display device 1 such that the row direction W1 (first panel direction D1) aligns with the X direction and the column direction W2 (second panel direction D2) aligns with the Y direction. Accordingly, the row direction W1 of the first liquid crystal display panel 220a and the row direction W1 of the second liquid crystal display panel 20b are parallel to the X direction and parallel to each other.

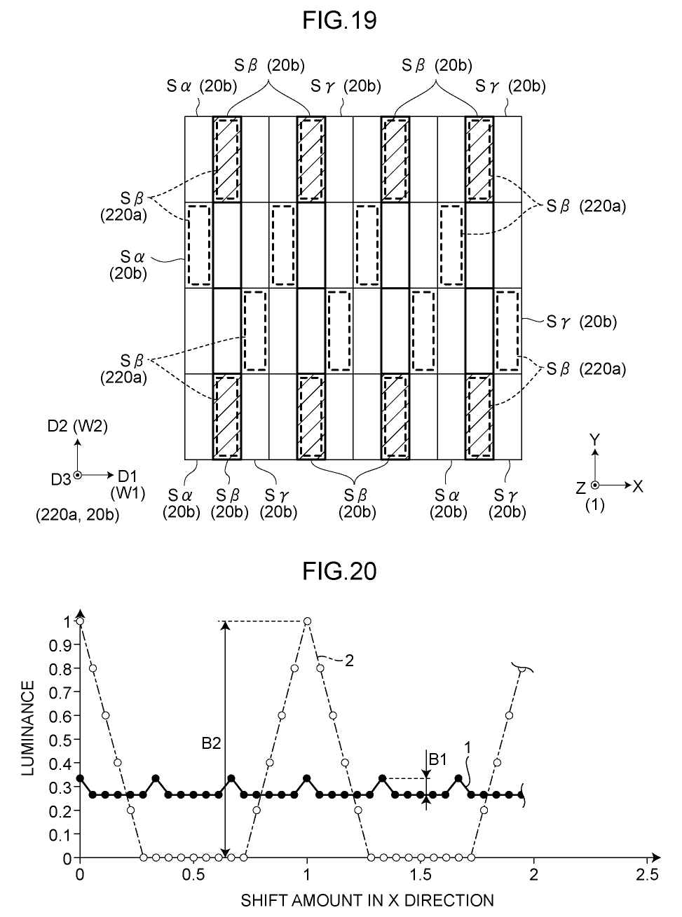

FIG. 19 is a diagram illustrating the positional relation between the sub pixels S of the first liquid crystal display panel 220a and the sub pixels S of the second liquid crystal display panel 20b in the display device 1 according to the third embodiment. The arrangement of the sub pixels S of the second liquid crystal display panel 20b is the same as that of the second liquid crystal display panel 20b according to the first embodiment (FIG. 5). A portion where each second sub pixel Sβ of the first liquid crystal display panel 220a and the corresponding second sub pixel Sβ of the second liquid crystal display panel 20b overlap each other as viewed in the Z direction is hatched.

The second sub pixels Sβ of the first liquid crystal display panel 220a overlap the first sub pixels Sα, the second sub pixels Sβ, and the third sub pixels Sγ of the second liquid crystal display panel 20b. Accordingly, in plan view, the second color filters CF2 of the first liquid crystal display panel 220a overlap the first color filters CF1, the second color filters CF2, and the third color filters CF3 of the second liquid crystal display panel 20b.

Similarly, in plan view, the first color filters CF1 and the third color filters CF3 of the first liquid crystal display panel 220a each overlap the first color filters CF1, the second color filters CF2, and the third color filters CF3 of the second liquid crystal display panel 20b.

FIG. 20 is a diagram illustrating the relation between the luminance of light transmitted through the second polarizing plate 40 and the amount of shift in the X direction between the sub pixels S of the first liquid crystal display panel 220a and the sub pixels S of the second liquid crystal display panel 20b when the display device 1 according to the third embodiment is in white display.

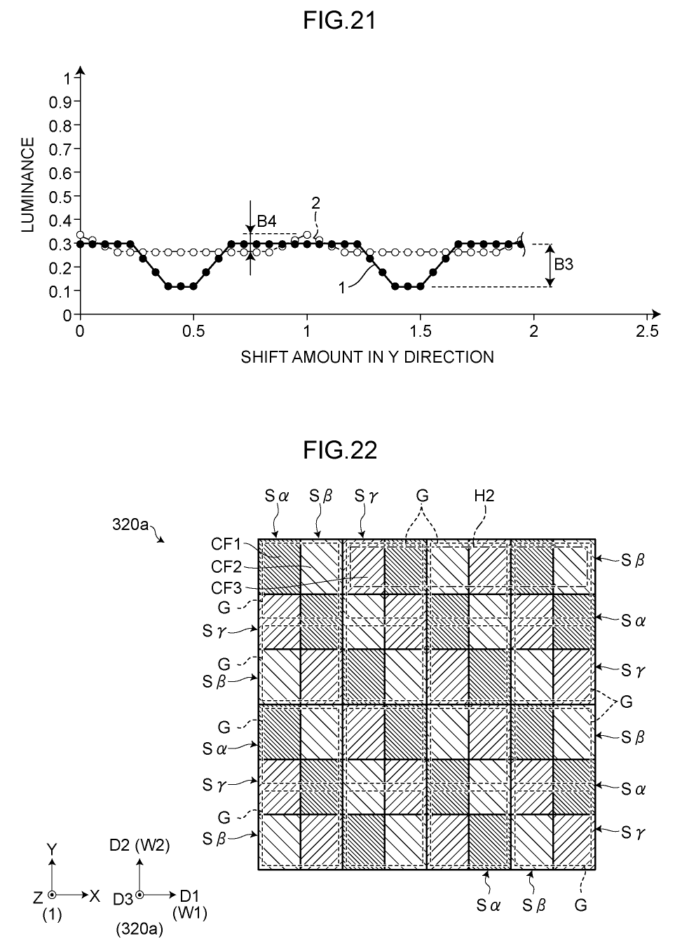

The vertical axis in FIG. 20 represents the luminance per six sub pixels S in a first area H1 illustrated in FIG. 18. The luminance of the six sub pixels S when all of light transmitted through the six sub pixels S of the first liquid crystal display panel 220a passes through the second liquid crystal display panel 20b is defined as 1 (the same applies to FIG. 21 to be described later). The six sub pixels S in the first area H1 correspond to two pixels G and include two first sub pixels Sα, two second sub pixels Sβ, and two third sub pixels Sγ.

The luminance corresponding to the amount of shift of the sub pixels S in the X direction in the display device 1 according to the third embodiment periodically varies, similarly to the display device 2 according to the comparative example. However, as for the variation range of the luminance in FIG. 20, the variation range B1 of the display device 1 according to the third embodiment is smaller than the variation range B2 of the display device 2 according to the comparative example. Accordingly, in the display device 1 according to the third embodiment, as compared to the display device 2 according to the comparative example, variation in the luminance due to shift between the sub pixels S in the X direction is reduced, and thus occurrence of moire can be reduced.

FIG. 21 is a diagram illustrating the relation between the luminance of light transmitted through the second polarizing plate 40 and the amount of shift in the Y direction between the sub pixels S of the first liquid crystal display panel 220a and the sub pixels S of the second liquid crystal display panel 20b when the display device 1 according to the third embodiment is in white display.

The luminance corresponding to the amount of shift of the sub pixels S in the Y direction in the display device 1 according to the third embodiment periodically varies, similarly to the display device 2 according to the comparative example. As for the variation range of the luminance in FIG. 21, the variation range B3 of the display device 1 according to the third embodiment is larger than the variation range B4 of the display device 2 according to the comparative example.

However, the degree of reduction of the variation range B1 of the display device 1 relative to the variation range B2 of the display device 2 according to the comparative example illustrated in FIG. 20 is greater than the degree of increase of the variation range B3 of the display device 1 relative to the variation range B4 of the display device 2 according to the comparative example illustrated in FIG. 21. Thus, the display device 1 according to the third embodiment can reduce occurrence of moire as compared to the display device 2 according to the comparative example.

### Fourth Embodiment

The following describes the display device 1 according to a fourth embodiment of the present disclosure with focus on differences from the display device 1 according to the above-described first embodiment.

FIG. 22 is a diagram illustrating an arrangement of the sub pixels S in a first liquid crystal display panel 320a included in the display device 1 according to the fourth embodiment of the present disclosure.

The first liquid crystal display panel 320a is smaller than the second liquid crystal display panel 20b in the size of each sub pixel S. The size of each sub pixel S of the second liquid crystal display panel 20b is the same as that of the second liquid crystal display panel 20b according to the above-described first embodiment, and is such that three sub pixels S continuously arranged in the row direction W1 correspond to one pixel G. The size of each sub pixel S of the first liquid crystal display panel 320a according to the fourth embodiment is such that six sub pixels S arranged in a matrix (row-column configuration) of two rows and three columns correspond to two pixels G.

The first liquid crystal display panel 320a and the second liquid crystal display panel 20b are different from each other in the ratio of the long side length and short side length of each sub pixel S. Specifically, the long side length of the sub pixel S of the first liquid crystal display panel 320a is shorter than that of the second liquid crystal display panel 20b, and the short side length of the sub pixel S of the first liquid crystal display panel 320a is longer than that of the second liquid crystal display panel 20b.

The sub pixels S in the first liquid crystal display panel 320a according to the fourth embodiment are disposed such that the first sub pixel Sα, the second sub pixel Sβ, and the third sub pixel Sγ are repeatedly arranged in the stated order in the row direction W1, and are disposed such that the first sub pixel Sα, the third sub pixel Sγ, and the second sub pixel Sβ are repeatedly arranged in the stated order in the column direction W2.

The first liquid crystal display panel 320a is disposed in the display device 1 such that the row direction W1 (first panel direction D1) aligns with the X direction and the column direction W2 (second panel direction D2) aligns with the Y direction. Accordingly, the row direction W1 of the first liquid crystal display panel 320a and the row direction W1 of the second liquid crystal display panel 20b are parallel to the X direction and parallel to each other.

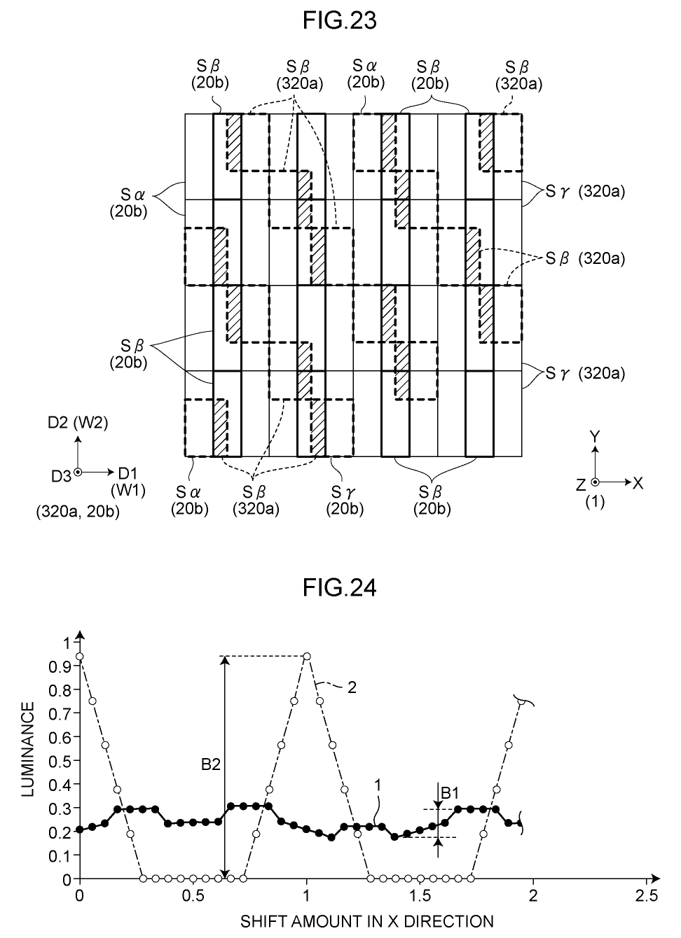

FIG. 23 is a diagram illustrating the positional relation between the sub pixels S of the first liquid crystal display panel 320a and the sub pixels S of the second liquid crystal display panel 20b in the display device 1 according to the fourth embodiment. The arrangement of the sub pixels S of the second liquid crystal display panel 20b is the same as that of the second liquid crystal display panel 20b according to the first embodiment (FIG. 5). A portion where each second sub pixel Sβ of the first liquid crystal display panel 320a and the corresponding second sub pixel Sβ of the second liquid crystal display panel 20b overlap each other as viewed in the Z direction is hatched.

The second sub pixels Sβ of the first liquid crystal display panel 320a overlap the first sub pixels Sα, the second sub pixels Sβ, and the third sub pixels Sγ of the second liquid crystal display panel 20b. Accordingly, in plan view, the second color filters CF2 of the first liquid crystal display panel 320a overlap the first color filters CF1, the second color filters CF2, and the third color filters CF3 of the second liquid crystal display panel 20b.

Similarly, the first color filters CF1 and the third color filters CF3 of the first liquid crystal display panel 320a each overlap the first color filters CF1, the second color filters CF2, and the third color filters CF3 of the second liquid crystal display panel 20b.

FIG. 24 is a diagram illustrating the relation between the luminance of light transmitted through the second polarizing plate 40 and the amount of shift in the X direction between the sub pixels S of the first liquid crystal display panel 320a and the sub pixels S of the second liquid crystal display panel 20b when the display device 1 according to the fourth embodiment is in white display.

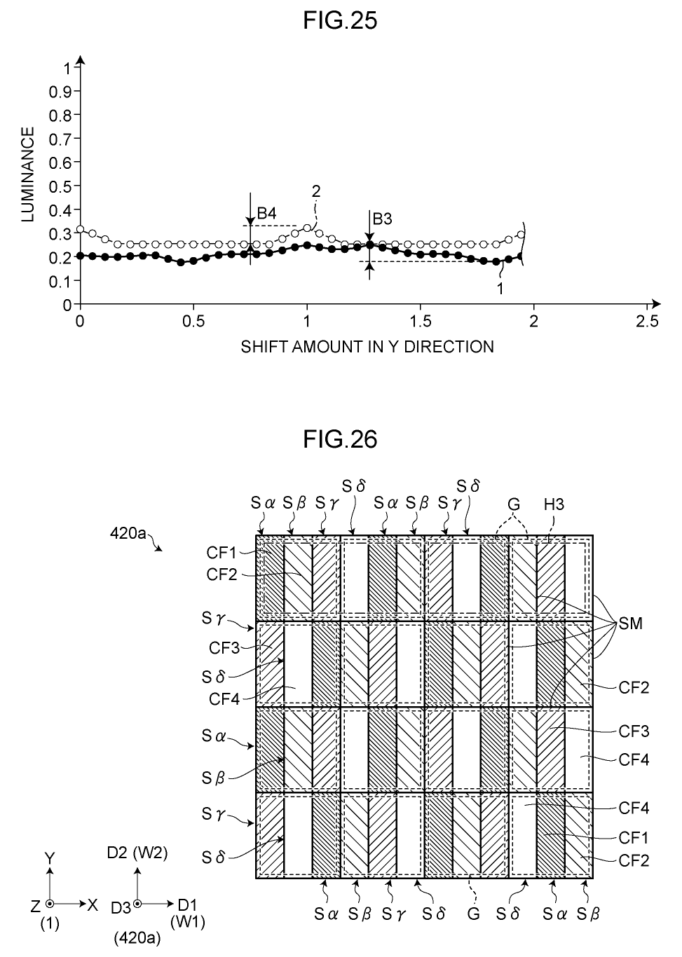

The vertical axis in FIG. 24 represents the luminance per six sub pixels S in a second area H2 illustrated in FIG. 22. The luminance of the six sub pixels S when all of light transmitted through the six sub pixels S of the first liquid crystal display panel 320a passes through the second liquid crystal display panel 20b is defined as 1 (the same applies to FIG. 25 to be described later). The six sub pixels S in the second area H2 are continuously arranged in the row direction W1 and include two first sub pixels Sα, two second sub pixels Sβ, and two third sub pixels Sγ.

The luminance corresponding to the amount of shift of the sub pixels S in the X direction in the display device 1 according to the fourth embodiment periodically varies, similarly to the display device 2 according to the comparative example. However, as for the variation range of the luminance in FIG. 24, the variation range B1 of the display device 1 according to the fourth embodiment is smaller than the variation range B2 of the display device 2 according to the comparative example. Accordingly, in the display device 1 according to the fourth embodiment, as compared to the display device 2 according to the comparative example, variation in the luminance due to shift between the sub pixels S in the X direction is reduced, and thus occurrence of moire can be reduced.

FIG. 25 is a diagram illustrating the relation between the luminance of light transmitted through the second polarizing plate 40 and the amount of shift in the Y direction between the sub pixels S of the first liquid crystal display panel 320a and the sub pixels S of the second liquid crystal display panel 20b when the display device 1 according to the fourth embodiment is in white display.

The luminance corresponding to the amount of shift of the sub pixels S in the Y direction in the display device 1 according to the fourth embodiment periodically varies, similarly to the display device 2 according to the comparative example. As for the variation range of the luminance in FIG. 25, the variation range B3 of the display device 1 according to the fourth embodiment is substantially the same as the variation range B4 of the display device 2 according to the comparative example. Thus, the display device 1 according to the fourth embodiment can reduce occurrence of moire as compared to the display device 2 according to the comparative example.

### Fifth Embodiment

The following describes the display device 1 according to a fifth embodiment of the present disclosure with focus on differences from the display device 1 according to the above-described first embodiment.

FIG. 26 is a diagram illustrating an arrangement of the sub pixels S in a first liquid crystal display panel 420a included in the display device 1 according to the fifth embodiment of the present disclosure. Each sub pixel S of the first liquid crystal display panel 420a and each sub pixel S of the second liquid crystal display panel 20b have the same shape and the same size in plan view. In the first liquid crystal display panel 420aaccording to the fifth embodiment, as well, three sub pixels S continuously arranged in the row direction W1 correspond to one pixel G.

The sub pixels S of the first liquid crystal display panel 420a according to the fifth embodiment further include fourth sub pixels Sδ having fourth color filters CF4 that are different in color from the first color filters CF1, the second color filters CF2, and the third color filters CF3. The color of the fourth color filters CF4 is white. The fourth color filters CF4 may be colorless and transparent.

The sub pixels S in the first liquid crystal display panel 420a are disposed such that the first sub pixels Sα, the second sub pixel Sβ, the third sub pixel Sγ, and the fourth sub pixel Sδ are repeatedly arranged in the stated order in the row direction W1, and are disposed such that the first sub pixel Sα and the third sub pixel Sγ are alternately arranged in the column direction W2 and the second sub pixel Sβ and the fourth sub pixel Sδ are alternately arranged in the column direction W2.

The first liquid crystal display panel 420a is disposed in the display device 1 such that the row direction W1 (first panel direction D1) aligns with the X direction and the column direction W2 (second panel direction D2) aligns with the Y direction. Accordingly, the row direction W1 of the first liquid crystal display panel 420a and the row direction W1 of the second liquid crystal display panel 20b are parallel to the X direction and parallel to each other.

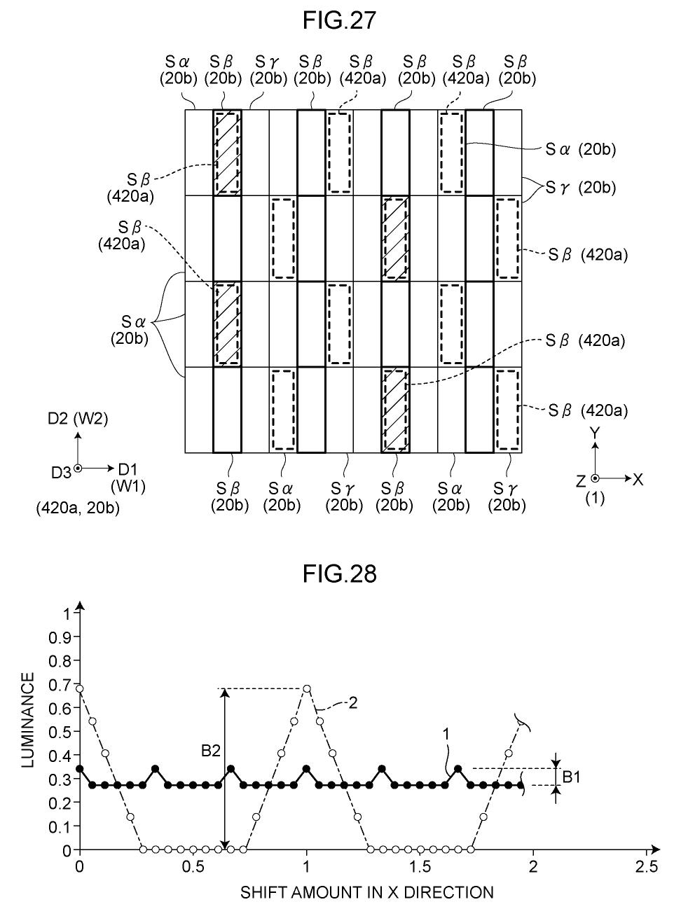

FIG. 27 is a diagram illustrating the positional relation between the sub pixels S of the first liquid crystal display panel 420a and the sub pixels S of the second liquid crystal display panel 20b in the display device 1 according to the fifth embodiment. The arrangement of the sub pixels S of the second liquid crystal display panel 20b is the same as that of the second liquid crystal display panel 20b according to the first embodiment (FIG. 5). A portion where each second sub pixel Sβ of the first liquid crystal display panel 420a and the corresponding second sub pixel Sβ of the second liquid crystal display panel 20b overlap each other as viewed in the Z direction is hatched.

The second sub pixels Sβ of the first liquid crystal display panel 420a overlap the first sub pixels Sα, the second sub pixels Sβ, and the third sub pixels Sγ of the second liquid crystal display panel 20b. Accordingly, in plan view, the second color filters CF2 of the first liquid crystal display panel 420a overlap the first color filters CF1, the second color filters CF2, and the third color filters CF3 of the second liquid crystal display panel 20b.

Similarly, in plan view, the first color filters CF1, the third color filters CF3, and the fourth color filters CF4 of the first liquid crystal display panel 420a each overlap the first color filters CF1, the second color filters CF2, and the third color filters CF3 of the second liquid crystal display panel 20b.

FIG. 28 is a diagram illustrating the relation between the luminance of light transmitted through the second polarizing plate 40 and the amount of shift in the X direction between the sub pixels S of the first liquid crystal display panel 420a and the sub pixels S of the second liquid crystal display panel 20b when the display device 1 according to the fifth embodiment is in white display.

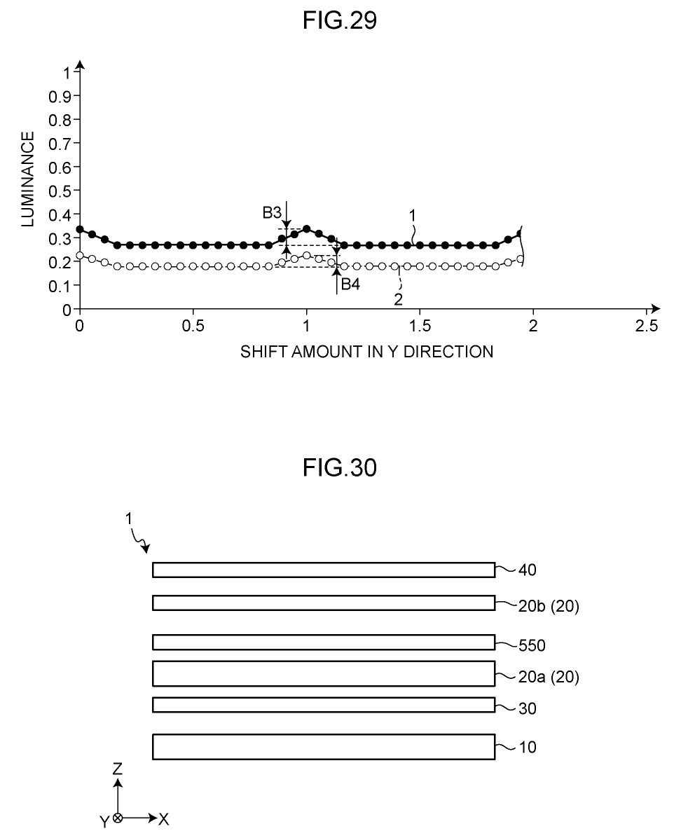

The vertical axis in FIG. 28 represents the luminance per 12 sub pixels S in a third area H3 illustrated in FIG. 26. The luminance of the 12 sub pixels S when all of light transmitted through the 12 sub pixels S of the first liquid crystal display panel 420a passes through the second liquid crystal display panel 20b is defined as 1 (the same applies to FIG. 29 to be described later). The 12 sub pixels S in the third area H3 are continuously arranged in the row direction W1 and include three first sub pixels Sα, three second sub pixels Sβ, three third sub pixels Sγ, and three fourth sub pixels Sδ.

The luminance corresponding to the amount of shift of the sub pixels S in the X direction in the display device 1 according to the fifth embodiment periodically varies, similarly to the display device 2 according to the comparative example. However, as for the variation range of the luminance in FIG. 28, the variation range B1 of the display device 1 according to the fifth embodiment is smaller than the variation range B2 of the display device 2 according to the comparative example. Accordingly, in the display device 1 according to the fifth embodiment, as compared to the display device 2 according to the comparative example, variation in the luminance due to shift between the sub pixels S in the X direction is reduced, and thus occurrence of moire can be reduced.

FIG. 29 is a diagram illustrating the relation between the luminance of light transmitted through the second polarizing plate 40 and the amount of shift in the Y direction between the sub pixels S of the first liquid crystal display panel 420a and the sub pixels S of the second liquid crystal display panel 20b when the display device 1 according to the fifth embodiment is in white display.

The luminance corresponding to the amount of shift of the sub pixels S in the Y direction in the display device 1 according to the fifth embodiment periodically varies, similarly to the display device 2 according to the comparative example. As for the variation range of the luminance in FIG. 29, the variation range B3 of the display device 1 according to the fifth embodiment is substantially the same as the variation range B4 of the display device 2 according to the comparative example. Thus, the display device 1 according to the fifth embodiment can reduce occurrence of moire as compared to the display device 2 according to the comparative example.

### Other modifications

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, the above-described liquid crystal display panel 20 may be a liquid crystal display of a vertical electric field type in which the common electrode CE is disposed on the second substrate 24 so as to face a plurality of sub pixel electrodes PE.

The first liquid crystal display panel 20a and the second liquid crystal display panel 20b may be disposed in the display device 1 in a state in which the first liquid crystal display panel 20a and the second liquid crystal display panel 20b are interchanged with each other. Specifically, the light source device 10, the first polarizing plate 30, the second liquid crystal display panel 20b, the first liquid crystal display panel 20a, and the second polarizing plate 40 may be disposed in the stated order from the negative Z side toward the positive Z side.

FIG. 30 is a diagram illustrating the configuration of the display device 1 according to a modification of the embodiments of the present disclosure. The display device 1 may further include a diffusion sheet 550 disposed between the first liquid crystal display panel 20a and the second liquid crystal display panel 20b.

Since light transmitted through the first liquid crystal display panel 20a is diffused by the diffusion sheet 550, occurrence of moire can be further reduced.

Preferable embodiments of the present disclosure are described above, but the present disclosure is not limited to such embodiments. Contents disclosed in the embodiments are merely exemplary, and various kinds of modifications are possible without departing from the scope of the present disclosure. For example, any modification performed as appropriate without departing from the scope of the present disclosure belongs to the technical scope of the present invention.

What is claimed is:

1. A display device comprising:
a light source device;
a first polarizing plate on which light from the light source device is incident and through which linearly-polarized light having a first polarization direction is transmitted;
a first liquid crystal display panel on which light transmitted through the first polarizing plate is incident;
a second liquid crystal display panel that is disposed so as to be spaced apart from the first liquid crystal display panel and on which light transmitted through the first liquid crystal display panel is incident; and
a second polarizing plate on which light transmitted through the second liquid crystal display panel is incident and through which linearly-polarized light having a second polarization direction different from the first polarization direction is transmitted, wherein
no polarizing plate is disposed between the first liquid crystal display panel and the second liquid crystal display panel,
a plurality of sub pixels are disposed in a matrix having a row-column configuration in each of the first liquid crystal display panel and the second liquid crystal display panel such that the sub pixels are arranged along a row direction and a column direction,
the sub pixels include
a first sub pixel having a first color filter,
a second sub pixel having a second color filter, and
a third sub pixel having a third color filter,
the first color filter, the second color filter, and the third color filter are different in color from each other, and
the first liquid crystal display panel and the second liquid crystal display panel are disposed such that at least the first color filter of the first liquid crystal display panel and the second color filter of the second liquid crystal display panel overlap each other in plan view.

2. The display device according to claim 1, wherein
the sub pixels each have a rectangular shape having a long side direction and a short side direction in plan view and are disposed such that the long side direction aligns with the column direction and the short side direction aligns with the row direction,
the sub pixels in the first liquid crystal display panel are disposed such that the row direction aligns with a first direction in plan view, and
the sub pixels in the second liquid crystal display panel are disposed such that the row direction aligns with a second direction different from the first direction in plan view.

3. The display device according to claim 2, wherein the row direction of the first liquid crystal display panel and the row direction of the second liquid crystal display panel form an angle of 90° in plan view.

4. The display device according to claim 2, wherein the row direction of the first liquid crystal display panel and the row direction of the second liquid crystal display panel form an angle of 45° in plan view.

5. The display device according to claim 2, wherein the sub pixels in each of the first liquid crystal display panel and the second liquid crystal display panel are
disposed such that the first sub pixel, the second sub pixel, and the third sub pixel are repeatedly arranged in the stated order in the row direction, and
disposed such that the first sub pixels are continuously arranged in the column direction, the second sub pixels are continuously arranged in the column direction, and the third sub pixels are continuously arranged in the column direction.

6. The display device according to claim 1, wherein
the sub pixels in the first liquid crystal display panel are disposed such that the first sub pixel, the second sub pixel, and the third sub pixel are repeatedly arranged in the stated order in each of the row direction and the column direction, and
the sub pixels in the second liquid crystal display panel are
disposed such that the first sub pixel, the second sub pixel, and the third sub pixel are repeatedly arranged in the stated order in the row direction, and
disposed such that the first sub pixels are continuously arranged in the column direction, the second sub pixels are continuously arranged in the column direction, and the third sub pixels are continuously arranged in the column direction.

7. The display device according to claim 1, wherein
the sub pixels each have a rectangular shape having a long side direction and a short side direction in plan view,
the first liquid crystal display panel and the second liquid crystal display panel are different from each other in a ratio of a length of each sub pixel in the long side direction and a length of each sub pixel in the short side direction,
the sub pixels in the first liquid crystal display panel are
disposed such that the first sub pixel, the second sub pixel, and the third sub pixel are repeatedly arranged in the stated order in the row direction, and
disposed such that the first sub pixel, the third sub pixel, and the second sub pixel are repeatedly arranged in the stated order in the column direction, and
the sub pixels in the second liquid crystal display panel are
disposed such that the first sub pixel, the second sub pixel, and the third sub pixel are repeatedly arranged in the stated order in the row direction, and
disposed such that the first sub pixels are continuously arranged in the column direction, the second sub pixels are continuously arranged in the column direction, and the third sub pixels are continuously arranged in the column direction.

8. The display device according to claim 1, wherein
the sub pixels further include a fourth sub pixel having a fourth color filter that is different in color from the first color filter, the second color filter, and the third color filter,
the sub pixels in the first liquid crystal display panel are
disposed such that the first sub pixel, the second sub pixel, the third sub pixel, and the fourth sub pixel are repeatedly arranged in the stated order in the row direction, and
disposed such that the first sub pixel and the third sub pixel are alternately arranged in the column direction and the second sub pixel and the fourth sub pixel are alternately arranged in the column direction, and
the sub pixels in the second liquid crystal display panel are
disposed such that the first sub pixel, the second sub pixel, and the third sub pixel are repeatedly arranged in the stated order in the row direction, and
disposed such that the first sub pixels are continuously arranged in the column direction, the second sub pixels are continuously arranged in the column direction, and the third sub pixels are continuously arranged in the column direction.

9. The display device according to claim 8, wherein the color of the fourth color filter is white.

10. The display device according to claim 1, further comprising a diffusion sheet disposed between the first liquid crystal display panel and the second liquid crystal display panel.
